(19) United States
(12) Patent Application Publication
(10) Pub. No.: US 2006/0285947 A1
(43) Pub. Date: Dec. 21, 2006

(54) Method and device for manipulating load containers

(75) Inventors: Rudolf Hansl, Linz (AT); Harald Sehrschon, Graz (AT)

Correspondence Address: WILLIAM COLLARD;COLLARD & ROE, P.C., 1077 NORTHERN BOULEVARD, ROSLYN, NY, 11576, US

(73) Assignee: TWG TRANSPORTGERATE GMBH, Wels (AT)

(21) Appl. No.: 10/563,029

(22) PCT Filed: Jun. 30, 2004
(86) PCT No.: PCT/AT04/00229

§ 371 Date: Feb. 13, 2006

(30) Foreign Application Priority Data
Jun. 30, 2003 (AT) AT 997/2003

(51) Int. Cl. B65G 65/00

(52) U.S. Cl. 414/277

(57) ABSTRACT

The invention describes a method and a load bearing device (23) for loading and unloading loading means into or out of a rack compartment of a rack store by means of a bearing device (24) arranged on an adjustable lifting platform (22). The bearing device (24) comprises a base frame (25) and coupling and upper slides (29, 30) that are adjustable synchronously to one another and relative to the base frame (25) via a pulley drive in travelling in or out direction (27, 28), and a conveying means (32) mounted on the upper slide (30) and coupled with a pulley drive. A maximum advance length (63) of the upper slide (30) is delimited by an overlapping area (64) between the base frame (25) and the upper slide (30). Between the base frame (25) and the lifting platform (22) an adjusting drive (67) and a linear guiding device (68) are arranged. The bearing device (24) is guided along the linear guiding device (68) and arranged adjustably on the lifting platform (22) via the actuating drive (67) in travelling in or out direction (27, 28) by about the length of the overlapping area (64).

The invention relates to a load bearing device, in particular for the loading and unloading of loading means into or out of a rack compartment of a rack store, a method and a conveyor device, as described in claims 1, 19 and 20.

A generic load bearing device is known from DE 200 12 197 U1, which comprises a fixed base frame and an upper slide mounted displaceably on the base frame by means of a pulley drive with a conveying means that runs around and is driven by a pulley, and a coupling slide mounted displaceably on the base frame. The coupling slide is provided with a driving gear, which is connected with a gear driven by the pulley drive arranged on the base frame, whereby the diameter of the driving gear is greater than that of the gear, and due to the thus created transmission of gear and driving gear, the conveying means is pulled back rapidly as the upper slide moves out. The pulley drive is in the form of an endless belt and is guided by a drive over two guide rollers mounted in driving out direction of the upper slide on the ends of the base frame and over the gear of the driver, whereby on both sides of the gear guide rollers are still arranged. The pulley of the pulley drive is guided by the larger driving gear over guide rollers mounted at the ends of the upper slide and the two ends of the pulley are connected with the coupling slide.

From DE 298 15 784 U1 a load bearing device is known, in particular for loading and unloading containers into or out of rack stores, which comprises an upper slide which is mounted displaceably by means of a sliding drive onto a fixed base frame. The sliding drive is in the form of a pulley drive. The upper slide is provided with a conveying means for the container to be transported. The conveying means is coupled with the pulley drive. The pulley of said pulley drive is guided by a drive arranged on the base frame over two guide rollers of the base frame crossing over two guide rollers of the upper slide, so that in this manner the conveying means is moved at the same speed opposite the travelling in or out direction of the upper slide.

A further design of a load bearing device is known from DE 42 05 856 A1. The latter comprises a fixed base frame and coupling and upper slides that are adjustable via a sliding drive in driving in and out direction synchronously to one another and relative to the base frame, as well at least one conveying means mounted on the upper slide and coupled with a pulley drive. The sliding drive for the upper slide attached to the base frame is in the form of a pulley drive and comprises a pulley which is guided by a driving gear over two guide rollers attached securely to the base frame and crosses over itself, and the two ends of the pulley are connected to the upper slide. The conveyor motor is coupled with the driving gear and arranged centrally on the coupling slide.

Furthermore, from EP 0 655 048 B1 a load bearing device is known for loading and unloading pallets from a rack compartment of a rack store with a conveyor vehicle that can be driven laterally adjacent to the rack store, which comprises two separately arranged bearing devices for the pallets, which are mounted on a common base frame and each have coupling slides adjustable by a first and second sliding motor relative to the base frame, and at least one upper slide adjustable by a third sliding motor independently of the two coupling slides relative to the base frame. The base frame is fixed onto the lifting platform of the conveyor vehicle. The first coupling slides of each bearing device adjacent to the base frame are provided with the first and second sliding motor, and a toothed wheel and a sprocket wheel are coupled respectively with the first and second sliding motor. Each toothed wheel meshes with a gear rack secured to the base frame, whilst a chain is placed around the sprocket wheel, which is guided by the sprocket wheel over sprocket wheels mounted in the driving out direction of the bearing device at the ends of the first coupling slide, and crosses over itself, and then is guided to securing points arranged opposite on the ends of the second coupling slide adjacent to the upper slide, and the two ends of the chain are securely connected to the second coupling slide. The diameter of the sprocket wheel is greater than that of the toothed wheel. Two sprocket wheels are coupled with the third sliding motor, whereby a chain is laid around each sprocket wheel and the chain of the respective sprocket wheel is guided over guide rollers mounted in driving out direction at the ends of the first coupling slide to guide rollers mounted opposite at the ends of the second coupling slide, and the two ends of the chain are connected with the upper slide.

The disadvantage of DE 42 05 856 A1 and EP 0 655 048 B1 is that on the travelling in and out movement of the coupling and upper slide the conveyor or slide motor is moved together with the coupling slide, which on the one hand requires greater drive power from the sliding motor to move the coupling and/or upper slide, and on the other hand in order to achieve sufficient rigidity of the coupling and/or upper slide, the cross sections of the coupling and upper slides entering the rack compartments have to be enlarged, and in this way the ratio of the available volume of the storage space to the storage volume of the rack store is considerably reduced.

With the aforementioned load bearing devices the conveying means is driven by a pulley means, which is guided by a drive on the base frame over a guide roller arranged on the coupling slide or a driving gear to a guide roller arranged on the upper slide and is coupled with the conveying means. If the coupling and upper slides are adjusted relative to one another in driving out direction, the guide roller of the upper slide and the guide roller or driving gear of the coupling slide move towards one another so far that they only just avoid collision. Due to the arrangement of the driving gear, guide rollers for the pulley, the upper slide can be driven out in both directions only by a maximum advancing length reduced by the area defined by the diameter of the driving gear and the guide roller and the spacing between the driving gear and guide rollers, so that necessarily on a full retraction of the upper slide there is a minimum overlap between the upper slide and the base frame. This minimum overlap means that the maximum possible retraction length of the bearing device driveable into the rack compartment is shortened, and with a possibility of loading twice as deeply in the rack store the container placed on the side remote from the aisle cannot be completely driven downwards, and therefore the centre of gravity of the stacked container is in the vicinity of the front end side of the conveying means as seen in driving out direction on the upper slide driven underneath the container or not on the conveying means of the upper slide driven underneath the container. In the first instance, the driven out upper slide on unloading can only be driven in again at low speeds, and the container can easily tip off the conveying means. In the second instance, the container cannot be removed from the rack compartment, as the frictional grip necessary for conveying the container from the storage space onto the conveying means is too low between the underside of the container and the bearing surface of the conveying means. In order to overcome this disadvantage it is necessary to design the base frame, coupling and/or upper slide to be greater by the length of the minimum overlap, which results in a widening of the rack aisle and therefore a less optimum use of space in the warehouse.

A further design of a generic load bearing device and a method for loading and unloading containers into and out of a rack compartment of a rack store is known from DE 198 01 856 C2. The load bearing device comprises a bearing device with a circulating, driveable conveying means, which on unloading a container from the rack compartment drives underneath the container, and via a wedge-shaped reversing region on the conveying means lifts the container from the storage space of the rack compartment, whereby during the driving out movement of the bearing device the conveying means on the underside of the container rolls off without a relative displacement of its bearing surface to the container opposite the travelling out direction, and subsequently drives back the bearing device with standing conveying means. On loading a container the bearing device drives out with standing conveying means and then the conveying means rolls off during the travelling in movement of the bearing device on the underside of the container without relative displacement of its standing surface to the container opposite the travelling in direction. This known method has proved to be very effective in practice and is characterised by having extremely short transfer or takeover times for the loading and unloading of containers into and out of a rack compartment.

The objective of the invention is to create a load bearing device and method, by which a load bearing means can be reliably deposited on or removed from the storage space of a rack store remote from the aisle using frictional grip alone, and to ensure that the amount of space available in a warehouse is made maximum use of.

The objective of the invention is achieved by means of the measures and features described in the characterising parts of claims 1 and 19. The surprising advantages thereof are that in this case, even with load bearing devices in which by means of the telescopic bearing device a maximum advancing length of the upper slide is determined by the overlapping area defined by the arrangement of the guide rollers etc. for the pulleys of the slide and/or conveying means drive between opposite end sides of the base frame and upper slide, that loading means arranged in the aisle-distant storage space and furthest from the rack aisle drive underneath beyond its centre of gravity up to at least its rear end face as viewed in driving out direction of the upper slide, and in this way frictional grip can be reliably established between the underside of the loading means and the bearing surface of the conveying means. In this way during the pushing on and off of the loading means to be unloaded from the rack compartment or loaded onto the rack compartment, the conveying means and the upper slide can be driven at greater speeds. As now also the rearmost loading means located in the storage space furthest from the aisle can be run underneath completely, loading means, especially of low weight and with an instable centre of gravity, as is the case for example with a container full of liquid, can be manipulated. The displacement path of the base frame of the bearing device can be specifically defined and the front end side of the base frame in the travelling out direction of the telescopic bearing device can drive in beyond a side delimitation of the lifting platform, and if necessary partly into a rack compartment, so that unlike the load bearing devices known from the prior art, a widening of the rack aisle due to the lengthening of the bearing device is not necessary, and the space available in the warehouse can be made optimum use of. By means of the load bearing device according to the invention however, more than two loading means can also be reliably loaded and unloaded behind one another onto and from both the two storage spaces.

The designs according to claims 2 and 3 are also advantageous, whereby an adjustment movement of the base frame is possible that is unconnected from the sliding movement of the coupling and upper slide, and the sliding and adjustment movement can take place in succession. It is also possible to move the coupling and upper slide and the base frame either together or individually.

By synchronising the sliding and adjusting motors the sliding and adjusting drive can be coupled together electrically, as described in claim 4, so that the adjusting and sliding movement of the base frame and the coupling and upper slide can be overlapped, and in this way the loading and unloading procedure can take place rapidly.

The developments according to claims 5 to 15 are also advantageous, whereby on the one hand a compact construction of the load bearing device is achieved and on the other hand the coupling and upper slide can be moved from their pushed in initial position into the completely pushed out working position, and the base frame can be moved from its central first end position relative to the vertical plane of symmetry of the load bearing device into an eccentric, second end position extending possibly over the lifting platform by means of only one sliding motor. Said sliding motor is preferably arranged fixed onto the lifting platform, so that no unnecessary masses have to be moved as well and an easy-maintenance arrangement is made possible and the small cross sections of the coupling and upper slide entering into the rack compartment and if necessary of the base frame have to dimensioned for bending strain with a driven out load. By changing the transmission of the driving gears the pushing out length of the coupling and upper slide respectively and the displacement path of the base frame can be influenced specifically depending on the dimensions of the loading means to be loaded and unloaded. The force-closed engagement between the frictional wheel and the frictional surface is also advantageous, whereby an especially low-noise adjustment of the telescopic bearing device is possible. As now the adjustment drive is formed by the sliding drive, an especially simple control of the sliding movement of the entire bearing device relative to the conveyor speed of the conveying means is possible.

In an advantageous manner the base frame can be moved relative to the lifting platform in both directions approximately by about the length of the overlapping area, whereby rack stores arranged on both sides of the rack operating device can be used with the load bearing device according to the invention, as described in claim 16.

According to claim 17 the adjustment path of the base frame in both directions is set, so that with a full extension of the bearing device on the one hand the overlapping area and on the other hand the respective safety distance between a loading and unloading side of the rack store and the side delimitation of the lifting platform is bridged.

A structurally simple design of a linear guiding device is described in claim 18.

The objective of the invention is however also achieved by the features described in claim 20. The surprising advantage in this case is that in addition to the advantages according to claim 1 and 19, the conveyor device provided with the load bearing device according to the invention, in particular the lifting platform can be designed to have a length in travelling in or out direction of the bearing device, which, in contrast to the load bearing devices known from the prior art, is designed to be shortened by the length of the overlapping area, and therefore the conveyor device drives along a relatively narrow rack aisle and the masses to be moved by the conveyor device can be reduced.

The invention is explained in more detail in the following with reference to the embodiments shown in the drawings, in which:

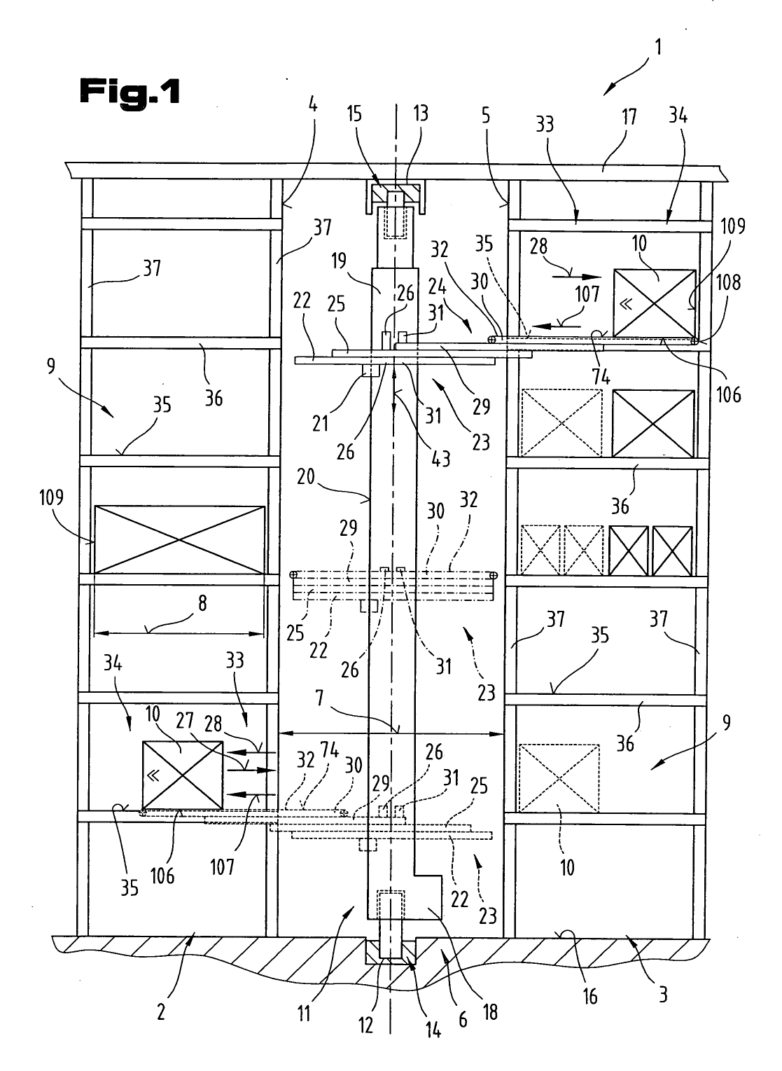

FIG. 1 shows a storage system with a conveyor vehicle with a load bearing device according to the invention in different height positions, in a simplified, schematic view;

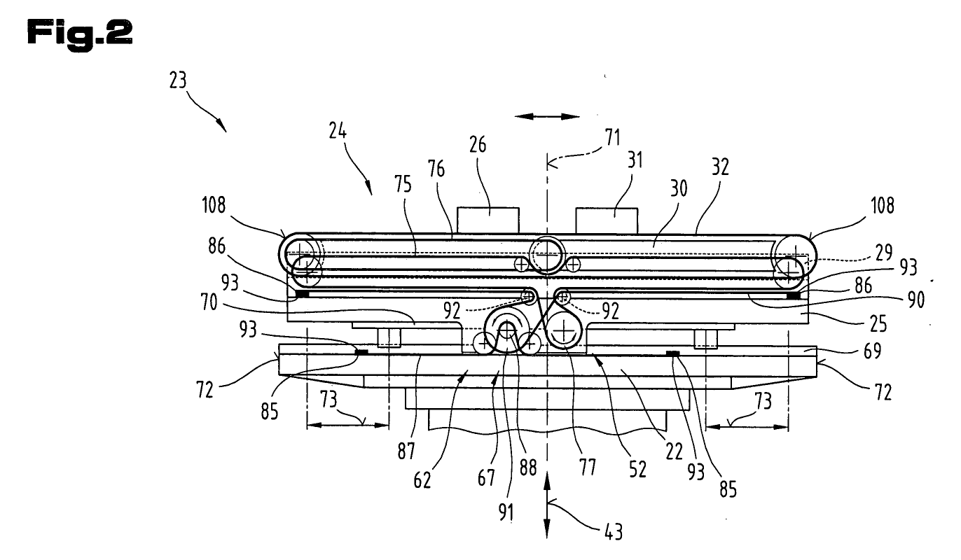

FIG. 2 shows a first design of the load bearing device according to the invention with a telescopic bearing device pushed in and in starting position on the lifting platform, in side view and simplified, schematic view;

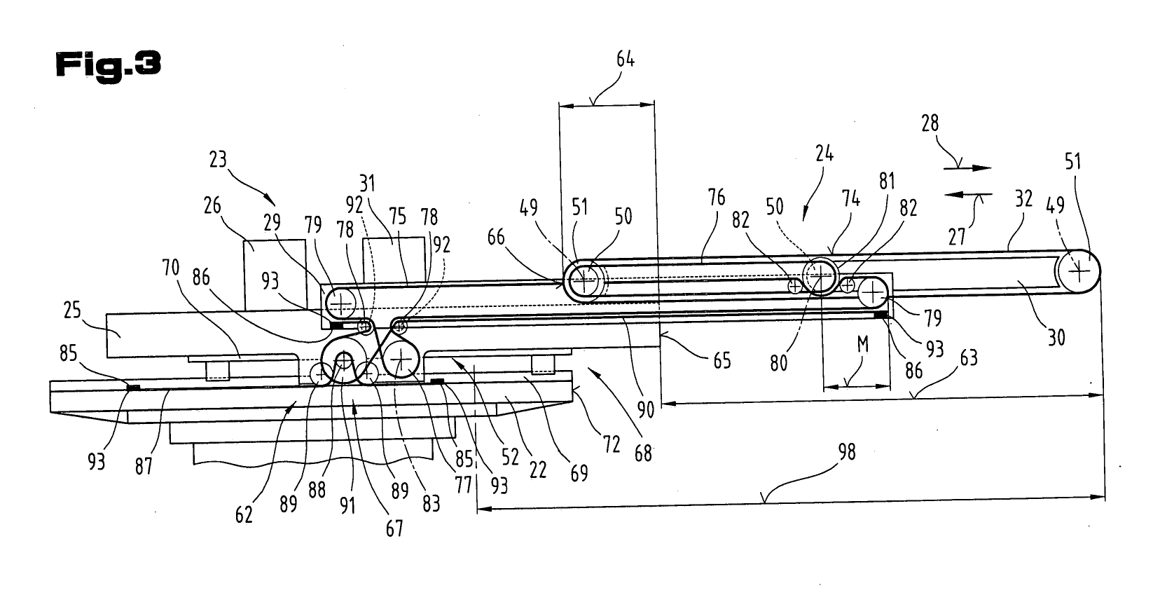

FIG. 3 shows the load bearing device according to the invention as in FIG. 2 with a full extension of the telescopic bearing device, in side view and simplified schematic view;

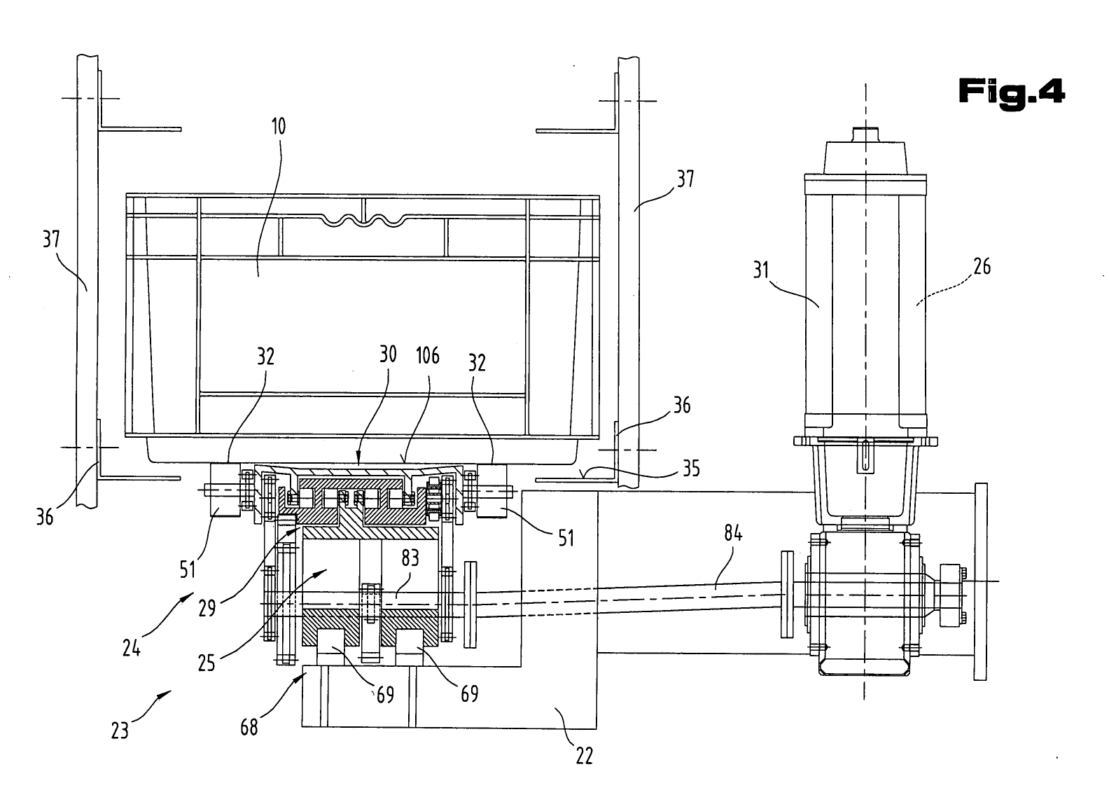

FIG. 4 shows a partial section of a rack store and the load bearing device according to the invention in the unloading procedure, with the bearing device completely driven underneath the loading means, and the loading means lifted from a storage space of the rack store and supported on the conveying means of the bearing device, in cross section in front view and in simplified, schematic view.

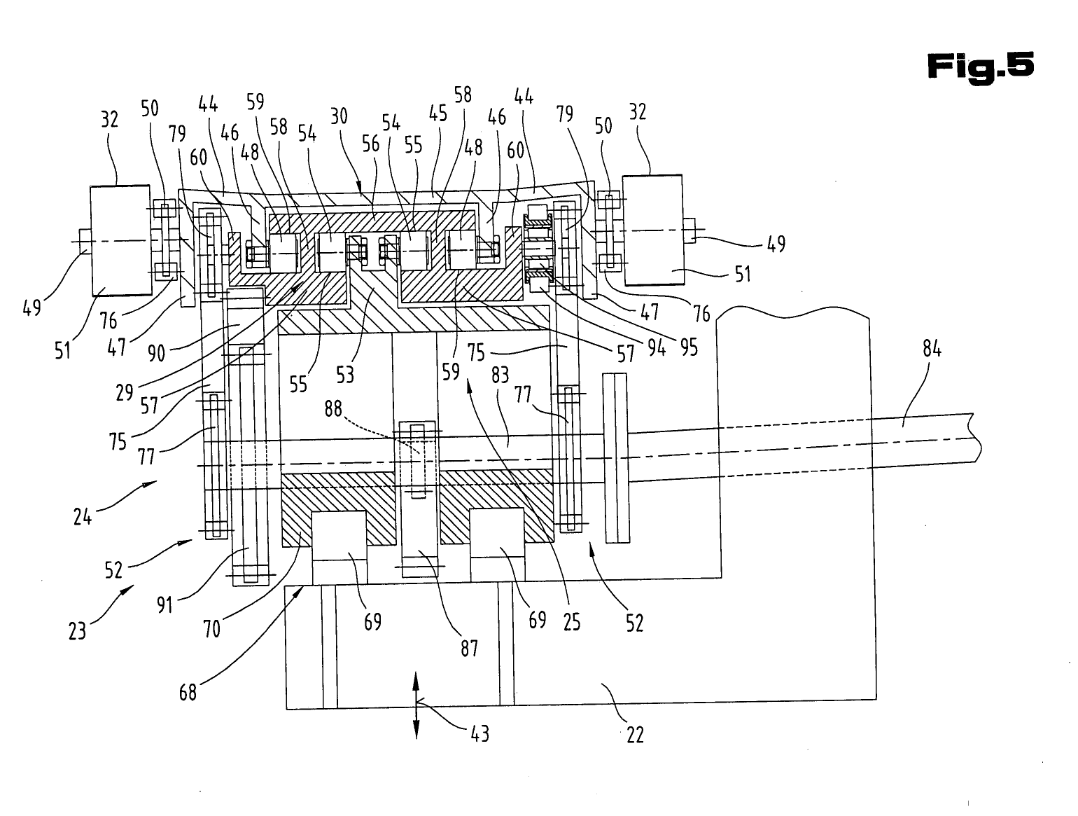

FIG. 5 shows a cross sectional enlargement of the load bearing device according to the invention as in FIG. 4;

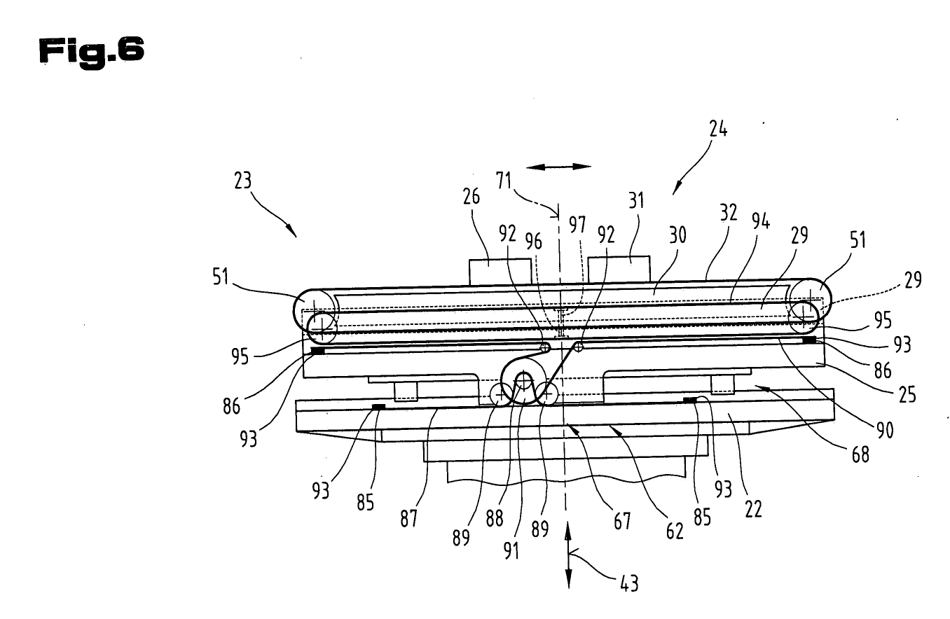

FIG. 6 shows the load bearing device according to FIG. 2 with only the sliding drive for the base frame, and coupling and upper slides in their initial position, in side view and simplified view.

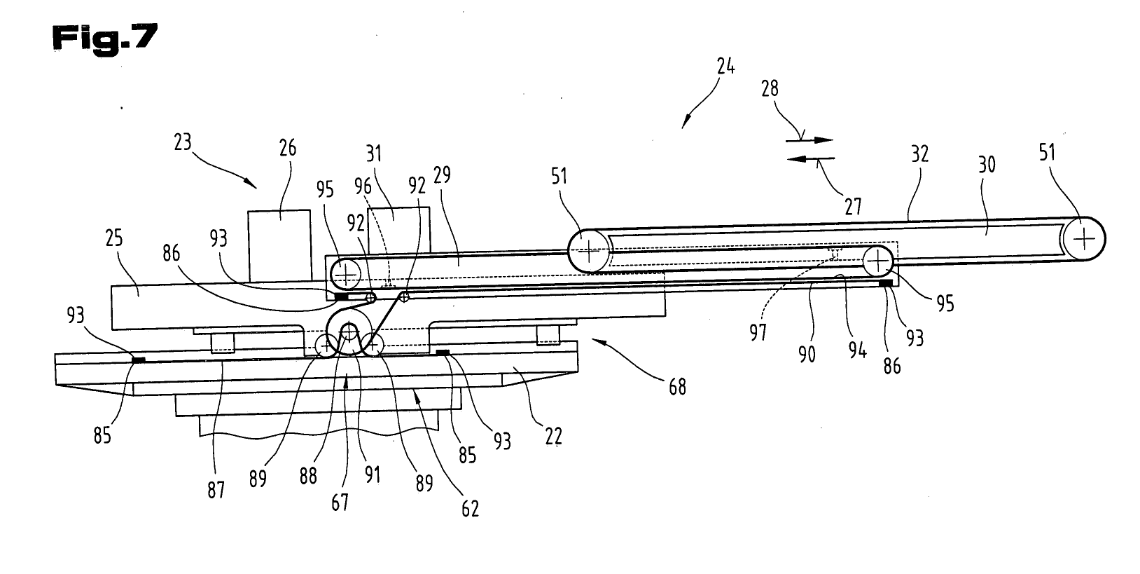

FIG. 7 shows the load bearing device according to claim 6 with the sliding drive for the base frame and the coupling and upper slide in the extended working position;

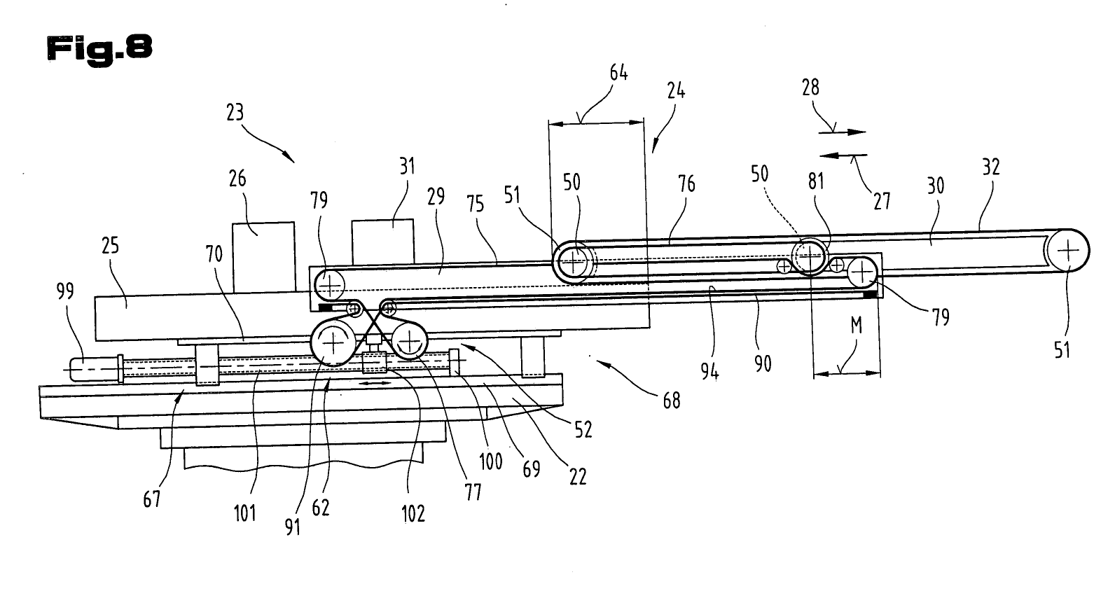

FIG. 8 shows a different embodiment of the load bearing device according to the invention, in a side view and simplified view;

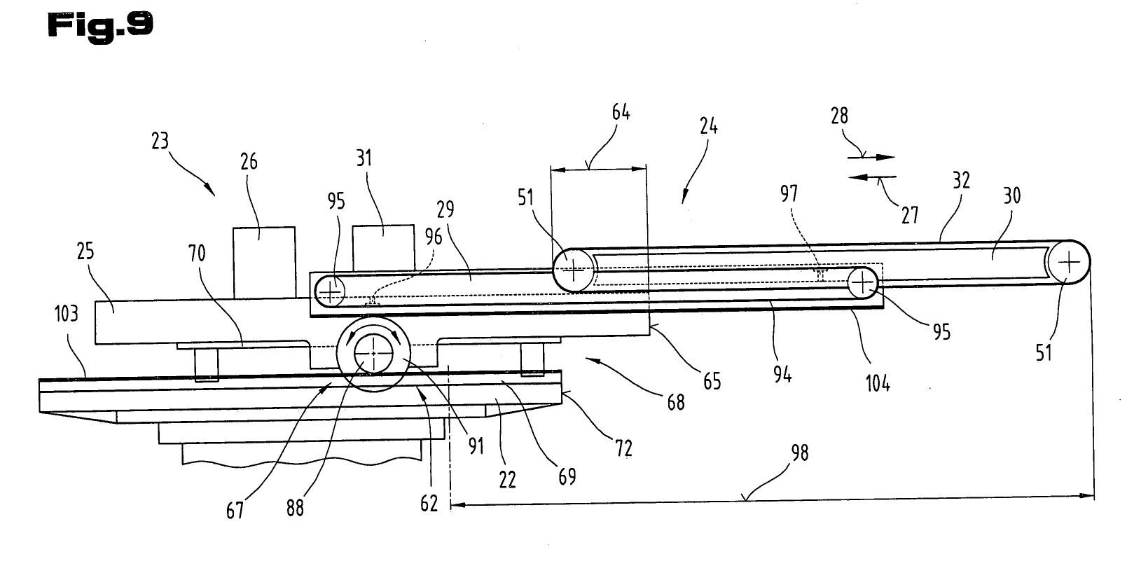

FIG. 9 shows a further embodiment of the load bearing device according to the invention, in a side view and simplified view.

First of all, it should be mentioned that in the various embodiments described the same parts are given the same reference numbers or component names, whereby the disclosures contained throughout the entire description can be applied to the same parts with the same reference numbers or component names. Also the details of position used in the description such as e.g. top, bottom, side etc. refer to the Figure currently being described and should be changed accordingly if there is a change in position. Furthermore, individual features or combinations of features of the different embodiments shown and described can represent independent, inventive solutions according to the invention in their own right.

FIG. 1 shows a storage system 1 in a simplified illustration and in a view which has two structurally corresponding rack stores 2, 3 which are symmetrical to one another. The distance between the facing loading and unloading sides 4, 5 of the two rack stores 2 forms a rack aisle 6. The distance defines a clear aisle width 7, which is designed to be only slightly larger than a maximum depth 8 of the loading means 10, in particular standard containers, to be loaded or unloaded from a rack compartment 9 of the rack store 2, 3. Along the rack aisle 6 and laterally next to the rack store 2, 3 there is a conveyor device 11, in particular a conveyor vehicle, such as a rail connected rack operating unit, that can be driven controlled by computer on guiding tracks 12, 13 in aisle direction. The conveying vehicle is in this case supported or guided by much simplified moving devices 14, 15 on the guiding track 12, in particular a drive rail, arranged on a horizontal standing surface 16 and the guiding track 13 secured to a cover 17 of the storage system 1, in particular a drive rail, and is adjustable by at least one drive arrangement 18 along the drive rails and comprises a mast 19 connected with the two moving devices 14, 15 and extending essentially perpendicular to the standing surface 16. The mast 19 is provided with a guiding arrangement 20, along which by means of a lifting drive 21 a horizontally running lifting platform 22 can be adjusted, in particular driven, by computer, in a direction that is essentially perpendicular to the standing surface 16. On the lifting platform 22 at least one load bearing device 23 according to the invention is arranged with a bearing device 24 enclosing the latter.

The bearing device 24 described more in detail below comprises a base frame 25 and only one sliding motor 26, for example a servomotor, stepping motor, coupling and upper slides 29, 30 that are adjustable in travelling in and out direction—according to the arrows 27, 28—synchronously relative to one another and relative to the base frame 25, and at least one, preferably two conveying means 32 mounted on the upper slide 30 and driveable via only one conveying motor 31, for example a servomotor, stepping motor, in particular a linear conveyor. The at least one conveying means 32 can be formed for example by a conveyor belt or a conveying chain or several conveying rollers arranged one behind the other. The sliding and conveying motor 26, 31 are arranged secured onto the lifting platform 22. It should be noted here that the bearing device 24 or the base frame 25, coupling and upper slides 29, 30 are designed to be adjustable in a horizontal plane running parallel to the standing surface 16 in travelling in and out direction—according to arrow 27, 28—perpendicular to the longitudinal extension of the shelf aisle 6 and in both directions relative to the lifting platform 22.

The coupling and upper slides 29, 30 that can be pulled out telescopically in relation to the lifting platform in both direction are mounted synchronously and displaceably in the same direction on the base frame 25, whereby a suitable working distance or travelling distance of the bearing device 24 is reached and by means of the bearing device 24, in particular the upper slide 30, viewed from the shelf aisle 6 in travelling out direction—according to arrow 28—at least two storage spaces 33, 34 in the rack compartment 9 arranged on behind the other can be approached, and starting from the rack aisle 6 the rack stores 2, 3 arranged on both sides of the rack aisle 6 can be used optionally for the loading and unloading of the loading means 10, regardless of whether the loading means 10 shown by a solid line is to be placed onto or removed from the storage space 34 remote from the rack aisle 6 or the loading means 10 shown by broken lines on the storage space 33 adjacent to the rack aisle 6 or two loading means 10 on the storage space 33, 34 close to the aisle or remote from the aisle.

The rack stores 2, 3 are constructed for example from a steel frame construction and have a plurality of storage spaces 35 arranged one above the other, which form the respective storage spaces 33, 34, and on which adjacent to one another in travelling out direction—according to arrow 28, several centrally aligned loading means 10, such as for example, rectangular boxes, containers made of plastic or cardboard or even pallets can be stacked in a row behind one another. The respective horizontal storage surface 35 is in this case for example formed by arms of angle profiles 36 with an L-shaped cross section that run towards one another. The angle profiles 36 arranged above one another in several horizontal planes are connected with rack supports 37 aligned vertically to the standing surface 16 and run respectively at a distance from one another perpendicular to the longitudinal direction of the rack aisle 6 or parallel to the travelling in and out direction—according to arrow 27, 28—of the coupling and upper slide 29, 30.

It should also be pointed out that the conveyor device 11 can also be formed by a fixed lifting bar rack operating device with a vertically and horizontally adjustable lifting platform or driveless transport system etc.

In the jointly described FIGS. 2 to 7 a first embodiment of the load bearing device 23 according to the invention is shown for the loading and unloading of loading means 10, in particular cubic, cylindrical containers, into and from the rack compartment 9 of the rack store 2, 3, with the conveyor vehicle shown in FIG. 1 driving laterally next to the rack stores 2, 3, in different views. The load bearing device 23 comprises at least one bearing device 24 arranged on the lifting platform 22 which is adjustable in vertical direction—according to the double arrow 43—which comprises the base frame 25 and the at least one coupling slide 29 and the at least one upper slide 30 arranged slidably thereon.

As shown in FIGS. 4 and 5 the base frame 25, coupling and upper slides 29, 30 are arranged above one another and on the main frame 25 the coupling slide 29 is forced along by a linear guide. The upper slide 30 is also positively driven by a linear guide on the coupling slide 29.

The profile-like upper slide 30 forms two U-profiles running at right angles to the longitudinal direction of the bearing device 24 spaced apart in parallel to one another and parallel to the travelling in and out direction—according to the arrows 27, 28 shown in FIG. 3, and a base profile 45 is arranged between the latter and preferably connected with a base 44 of the two U-profiles. The U-profiles respectively comprise an inner and outer profile arm 46, 47 extending from the base 44 in the direction of the main frame 25. The upper slide 30 is mounted displaceably via the linear guide on the coupling slide 29 arranged between the adjacent inner profile arms 46 and the coupling slide 29. In the present embodiment the linear guide is formed by running blocks 48 arranged laterally on the adjacent inner profile arms 46 in the longitudinal direction thereof at intervals behind one another and mounted freely rotatably on the profile arms 46. Preferably, the linear guide extends over approximately the entire length of the upper slide 30. On each of the outer profile arms 47 in travelling out direction—according to the arrow 28 in FIG. 3—of the telescopic bearing device 24 at the ends of the upper slide 30 laterally projecting axial pins 49 are arranged, on which a guide roller 50 for a pulley of a conveying means drive 52 described in more detail below (cf. FIG. 3) and a guide roller 51 for the conveying means 32 are mounted rotatably. In this case the guide rollers 50, 51 are connected together rigidly at one end of the upper slide 30.

The base frame 25 is designed as a profile rail and is provided on an upper side facing the coupling slide 29 with an extension 53. The linear guide is formed by running blocks 54 arranged on the extension 53 on both sides at intervals and mounted freely rotatably on the extension 53. Preferably, the linear guide extends over almost the entire length of the base frame 25.

On the profile-like base frame 25 the coupling slide 29 guided in a rolling manner by the running blocks 54 on running tracks 55 is supported, which coupling slide comprises two I-profiles, which have a joint upper belt 56 and lower belts 57 running towards one another, as well as webs 58 extending between the upper and lower belt 56, 57, and the inner sides of the upper and lower belt 56, 57 facing the coupling slide 29 or facing one another respectively form the two running tracks 55 for the running blocks 54. The inner sides of the upper and lower belt 56, 57 facing away from the coupling slide 29 or facing away from one another form running tracks 59 for the running blocks 48 of the upper slide 30.

A further design, which is not shown, is that the linear guide between the coupling and upper slide 29, 30 and the base frame 25 and coupling slide 29 is not, as shown in the embodiments, formed by a roller guide but by a sliding guide, whereby the running blocks 48, 54 are replaced by suitable slide bars, preferably made of plastic, which in turn are supported on the running tracks 55, 59. Said sliding bars or the running blocks 48, 54 form height guiding elements of the linear guide.

By means of this linear guide the base frame 25, coupling and upper slides 29, 30 are guided in an essentially play-free manner in perpendicular direction to the load bearing. For the essentially play-free guiding of the base frame 25 and coupling slide 29 or coupling slide 29 and upper slide 30 at right angles to the longitudinal extension of the bearing device 24, the linear guide also between the running blocks 48, 54 arranged behind one another at intervals comprise slide bars, which are not shown in more detail, which in turn are supported on the opposite, vertical side surfaces of the extension 53 facing away from one another and the webs 58 or on the webs 58 and the inner profile arms 46. Said slide bars form the side guiding elements of the linear guide.

On each lower belt 57 of the aforementioned profile-like coupling slide 29 there is an arm 60 running parallel to the web 58 and extending between the inner and outer profile arms 46, 47, whereby on a first arm 60 in travelling out direction—according to arrow 28—of the telescopic bearing device 24 at the ends of the coupling slide 29 there are guide rollers 79, 95 for a pulley of a conveying means and sliding drive 52, 62 described in more detail below (cf. FIG. 3) and on a second arm 60 in travelling out direction—according to arrow 28—of the telescopic bearing device 24 at the ends of the coupling slide 29 guide rollers 79 of the conveying means device 52 are mounted freely rotatably.

As can be seen from FIG. 3, the main frame 25, coupling and upper slides 29, 30 are designed respectively to have approximately the same length in travelling in or out direction—according to arrow 27, 28. A maximum pushing out length 63 of the completely moved out upper slide 30, measured between the front end sides of the main frame 25 and upper slide 30 in travelling out direction—according to arrow 28—, is less than the maximum length of the main frame 25 and is defined by an overlapping area 64 between the opposite end sides 65, 66 of the main frame 25 and the upper slide 30.

As can be seen from the overview of FIGS. 2 to 5, the entire bearing device 24 is designed to be adjustable in travelling in or out direction—according to arrow 27, 28—between the pushed in initial position shown in FIG. 2 and the pushed out working position shown in FIG. 3.

For this between the bearing device 24 or the base frame 25 and the lifting platform 22 at least one actuating drive 67 and at least one linear guiding device 68 running parallel to the travelling in and out direction—according to arrow 27, 28—is arranged. The linear guiding device 68 preferably has two guiding bars 69 running at right angles to the travelling in or out direction—according to arrow 27, 28—spaced apart and parallel to one another and fixed onto the lifting platform 22 and a slide 70 secured to the base frame 25, whereby the bearing device 24 is mounted by the slide 70 on the two guiding bars 69 preferably slidably or guided along the latter and is arranged adjustably by the actuating drive 67 in the direction of the rack compartment 9 by the length of the overlapping area 64 relative to the lifting platform 22. The linear guiding device 68 can be formed by a slide, ball track, roller track, cross roller or running roller guide. Naturally, the slide 70 can also be secured onto the lifting platform 22 and the guiding bars 69 fixed onto the base frame 25, but this is not shown in detail.

The base frame 25 of the bearing device 24 can be driven out from the first end position over a vertical plane of symmetry 71 and in both directions up to beyond the side delimitations 72 of the lifting platform 22 into the second end position—at least by the length of the overlapping area 64. An adjustment path 73 of the base frame 25 is designed to be identical on both sides and corresponds to the overlapping area 53, preferably in addition to the safety distance between the loading and unloading side 4, 5 and the respective side delimitation 72 of the lifting platform 22 and amounts to between 130 mm and 250 mm, in particular 150 mm and 230 mm, for example 170 mm.

As can be seen from the figures, the upper slide 30 is provided with two conveying means 32 running at a distance from one another parallel to one another and parallel to the travelling in or out direction—according to arrow 27, 28—, which conveying means are formed by an endlessly running chain or a toothed belt, and are guided by the guide rollers 51 rotatably mounted on the axial pins 49 arranged in the end regions of the upper slide 30. The two conveying means 32 form with their upper strand side facing away from the coupling slide 29 a horizontal bearing surface 74 for the loading means 10 to be transported or the container, and each conveying means 32 is drive-connected or coupled with a conveying means drive 52. The upper slide 30 or the bearing surface 74 of the conveying means 32 has a length in travelling in or out direction—according to arrow 27, 28—which corresponds approximately to the maximum depth 8 of a loading means 10 to be loaded or unloaded.

Each conveying means drive 52 comprises two pulley drives, which respectively have a first and second pulley means 75, 76, which are designed to run endlessly. The endlessly running first pulley means 75 is guided by a driving gear 77 arranged fixed on the base frame 25 over two guide rollers 78 mounted centrally on the base frame 25, and guide rollers 79 mounted in travelling out direction—according to arrow 28—of the telescopic bearing device 24 at the ends of the coupling slide 29. The endless second pulley means 76 is arranged on the upper slide 30 and guided around the guide rollers 50 mounted on one of the ends and roughly centrally on the upper slide 30. The guide roller 50 mounted centrally on the upper slide 30 is rigidly connected via a coupling shaft 80 arranged on the upper slide 30 with a drive roller 82 mounted rotation-fast thereon, whereby the drive roller 81 during the travelling in and out movement rolls off the coupling and upper slide 29, 30 onto the first pulley means 75. The guide roller 50 is thus connected with the drive roller 81 driven by the first pulley means 75. Guide rollers 82 mounted roughly centrally on the upper slide 30 guide the first pulley means 75 with an angle of contact on the respectively allocated drive roller 81.

The pulley means 75, 76 are in the form of a chain, a toothed belt or a cable pull, whereby the guide rollers 50, 78, 79, 82, the driving gear 77 and the drive roller 81 mounted on the upper slide 30 are designed either as chain wheels, a toothed or guide disc. It is essential that the torque of the driving gear 77 is transmitted essentially slip-free to the respective conveying means 32.

The driving gears 77 of the two pulley drives—see FIGS. 4 and 5—are connected together rotation-fast on a common drive shaft 83 and are coupled via a rotational movement transmission member 84, in particular a cardan shaft, such as an articulated shaft, with the conveyor motor 31 arranged fixed onto the lifting platform 22. The rotational direction of the conveyor motor 31 is designed to be reversible, so that the conveying direction of the conveying means 32 can be changed as desired. The arrangement of the conveyor motor 31 separately from the coupling and upper slide 29, 30 has proved advantageous, as on the one hand mobile connection lines are no longer required and on the other hand no unnecessary masses have to be moved as well on the coupling and upper slide 29, 30, and therefore conveyor motors 31 with high drive power, which necessarily increase the size of the unit, can be used, and thereby also the acceleration and deceleration phase of the synchronously driven conveying means 32 can be shortened during the loading and unloading of a container from the rack compartment 9, so that the containers can be loaded and unloaded rapidly.

For the adjustment of the telescopic bearing device 24 from its initial position according to FIG. 6 in travelling out direction—according to arrow 28—into the working position according to FIG. 7, the load bearing device 23 has the sliding drive 62 shown in more detail in FIGS. 6 and 7, by which the coupling and upper slide 29, 30 can be moved in travelling in and out direction—according to arrow 27, 28—synchronously to one another and relative to the base frame 25. In this shown design the sliding drive 62 forms the actuating drive 67 and has a first, second and third pulley drive with a first, second and third transmission means. The first transmission means of the first pulley drive is formed by a first pulley means 87, for example a chain, toothed belt or cable pull, which is guided by a first driving gear 88 fixed onto the base frame 25 over two guide rollers 89 mounted on the base frame 25 and the two ends 85 of the first pulley means 87 are connected at securing points 93 with the lifting platform 22. The first transmission means engages positively with the driving gear 88.

The second transmission means of the second pulley drive is formed by a second pulley 90, for example a chain, a toothed belt or cable pull, which is guided by a second driving gear 91 mounted on the base frame 25 over two guide rollers 92 mounted centrally on the base frame 25 to securing points 93 arranged in travelling out direction—according to arrow 28—of the bearing device 24 at the ends of the coupling slide 29, and the two ends 86 of the two pulley 90 are securely attached to the coupling slide 29. The second transmission means engages positively with the driving gear 91.

It is not shown that the two driving gears 88, 91 are mounted rotation-fast on a common drive shaft. Said drive shaft is coupled with an also not shown rotational movement transmission member, in particular a cardan shaft, such as an articulated shaft, with the sliding motor 26 arranged securely on the lifting platform 22.

The third transmitting means of the third pulley drive is formed by a third pulley 94, for example a chain, a toothed belt or cable pull, which is guided endlessly running around two guide rollers 95 mounted in travelling out direction—according to arrow 28—of the telescopic bearing device 24 on the ends of the coupling slide 29, whereby the coupling slide 29 is coupled mechanically by a first work drive element 96 with the base frame 25 and the upper slide 30 is coupled via a second work drive element 97 with the coupling slide 29. In this case the first work drive element 96 is connected in turn with a lower strand of the pulley 94 facing the base frame 25 and with a frame of the base frame 25. The second work drive element 97 is in turn connected with an upper strand of the pulley 94 facing the upper slide 30 and with a frame of the upper slide 30. In this way via the three pulley drives the base frame 25, coupling and upper slide 29, 30 can be driven out in both directions equally far depending of the direction of rotation of the driving gear 88, 91 relative to the vertical plane of symmetry or the lifting platform 22.

The diameter of the driving gear 91, around which the second pulley means 90 is laid, is greater than that of the driving gear 88, around which the first pulley 87 is laid. The driving gears 88, 91 form a transmission gear, so that the base frame 25 is driven in a fixed reduction ratio to the upper slide 30.

The rotational direction of the sliding motor 26 is reversible, so that the bearing device 24 can driven in in relation to the lifting platform 22 on both sides into the rack compartments 9 of the rack stores 2, 3 arranged on both sides of the rack operating device.

If the drive shaft and thereby the two driving gears 88, 91 are now set into rotation a displacement of the entire bearing device 24 or an adjustment of the base frame 25 in the direction of the rack compartment 9 of one of the rack bearings 2, 3 is carried out by the adjustment path 73 shown in FIG. 2, and at the same time a moving out movement of the coupling and upper slide 29, 30 is performed, whereby the transmission ratio of the two driving gears 88, 91 can be selected so that with a movement of the base frame 25 of for example 150 mm in addition to that of the upper slide the movement is up to 1110 mm. This produces for example a transmission ratio of i=3.7. The upper slide 30 thus covers twice the distance of the coupling slide 29. With a full extension of the telescopic bearing device 24 the entire length 98 corresponds, as shown in FIG. 3, to the sum of the adjustment path 73 plus the extension lengths of the coupling and upper slide 29, 30, and amounts in the present example to 1260 mm. If one assumes that the upper slide 29 has a length of about 1260 mm, and a safety distance between the loading and unloading side 4, 5 and the respective side delimitation 72 of the lifting platform 22 of about 50 mm, and the rack depth is 1200 mm, with a full extension of the upper slide 30 the conveying means 32, in particular with flat bearing surface 74, move out up to at least one rear upright end surface 109 (cf. FIG. 1) as viewed in travelling out direction—according to arrow 28—of the upper slide 30, so that even the loading means 10 placed at the aisle-remote storage space 34 (cf FIG. 1) can be driven down completely. In this case the conveying means 32, in particular with its flat bearing surface 74 can be slightly overtaken, for example by about 10 mm to 30 mm even the rear upright end surface 109 as viewed in travelling out direction—according to arrow 28—of the upper slide 30.

By changing the transmission of the driving gears 88, 91 with the given adjustment path 73 the extension lengths of the coupling and upper slide 29, 30 and thereby the entire driving out length 98 can be influenced specifically. The adjustment path 73 corresponds only to a fraction of the extension length 63 of the coupling and/or upper slide 29, 30.

The bearing device 24 must be able to be move out equally far in both directions, which is why the guide roller 50 and drive roller 81 are arranged centrally and the guide roller 82 on both sides next to the drive roller 81 on the upper slide 30. If the coupling and upper slide 29, 30 are now driven out in driving out direction—according to arrow 28—due to the relative displacement between the upper and coupling slide 29, 30 the drive and guide roller 81, 50, 82 are moved so far in the direction of the guide roller 70 that they only just avoid collision. With a full extension of the upper and coupling slide 29, 30 the drive and guide rollers 81, 50, 82 lie just next to the guide roller 79 for the pulley 75 of the conveying means drive 52 arranged at the front side, as shown in FIG. 3. The upper slide 30 can therefore only be driven out by the maximum extension length 63 reduced by a minimum dimensions defined by the diameter of the guide rollers 79, 82 and the radius of the drive roller 81 and the spacing between the drive and guide roller 81, 50, 82, so that necessarily with a full extension of the coupling and upper slide 29, 30 there is a minimum overlap or the overlapping area 54 is formed between the upper slide 30 and the base frame 25. As the bearing device 24 is designed to be telescopic in both directions, the overlapping area 64 corresponds approximately to twice the minimum dimension “M”. For a better overview of the pulley guide the minimum dimension “M” is not entered to scale relative to the overlapping area 64.

As can be seen from this view, this overlapping area 64 is formed only because the pulley 75 of the conveying means drive 52 driving the conveying means 32 is guided by the driving gear 77 on the base frame 25 over the guide rollers 79 arranged on the face end of the coupling slide 29, and the drive and guide rollers 81, 82 arranged in the middle of the upper slide 30 engage with the pulley 75.

In FIG. 8 a further embodiment variant of the load bearing device 23 according to the invention is shown in side view and in a much simplified drawing. The load bearing device 23 encloses the at least one bearing device 24, which comprises the base frame 25 and the coupling and upper slide 29, 30 adjustable by the sliding drive 62 in travelling in and out direction—according to arrow 27, 28—synchronously relative to one another and relative to the base frame 25, as well as two conveying means 32 mounted on the upper slide 30. Each conveying means 32 is, as already described above, coupled respectively with a conveying means drive 52. The design of the conveying means drive 52 corresponds to the one that has already been described in the preceding FIGS. 2 to 7.

The sliding drive 62 comprises the second and third pulley drive described above with the second and third pulley 90, 94. The design and arrangement of the second and third pulley 90, 94 can also be transferred identically to this figure. In contrast to the preceding FIGS. 2 to 7 the first pulley drive is dispensed with and replaced by a linear drive. The driving gear 91 of the sliding drive 62 is coupled in turn with the sliding motor 26 arranged fixed onto the lifting platform 22.

The actuating drive 67 is arranged separately from the sliding drive 62 and is in the form of an electrically operated linear drive in the form of threaded spindle drive, and comprises an electric actuating motor 99, by means of which a threaded spindle 101 mounted rotatably on one side by the latter and on the other side by a bearing bock 100, can be driven. The threaded spindle 101 is surrounded by a spindle nut 102 which is connected in a fixed manner to the base frame 25 by a bridge, so that depending on the direction of rotation of the actuating motor 99 the threaded spindle 102 is moved left or right and the bearing device 24, in particular the base frame 25, is moved in travelling in or out direction—according to arrow 27, 28. The actuating drive 67, in particular the actuating motor 99, the treaded spindle 101 and the bearing block 100 are fixed onto the lifting platform 22. The sliding motor and the actuating motor 26, 99 are purposely synchronised. In this case the sliding motor and the actuating motor 26, 99 receive a signal from a control at the same time and are both switched on simultaneously.

In a different, embodiment variant, not shown in detail, the actuating drive 67 is formed by a pneumatic or hydraulic linear drive, in particular a piston rod-free cylinder. This cylinder is arranged on the lifting platform 22 and a slide that is displaceable in the longitudinal direction thereof is connected securely to the base frame 25. Advantageously for the first and second end position of the base frame 25 the respective end position of the cylinder is approached so that a sufficient degree of positioning precision is achieved. The cylinder here comprises the linear guiding device 68. In a further not illustrated design of the actuating drive 67 the latter is formed by a crank driving mechanism.

In FIG. 9 a further embodiment variant of the load bearing device 23 with the bearing device 24 according to the invention is shown in side view and in a much simplified, schematic view. To provide a better overview only the sliding drive 62 with the actuating drive 67 is shown. A conveying means drive 52 is allocated to each conveying means 32 which is not shown in this Figure. The bearing device 24 in turn comprises the base frame 25 and the coupling and upper slide 29, 30 adjustable via the sliding drive 62 in travelling in and out direction—according to arrow 27, 28—synchronously and relative to the base frame 25, and the conveying means 32 mounted on the upper slide 30 and driveable by the conveying means drives 52. By means of this sliding drive 62 the coupling and upper slide 29, 30 is designed to be displaceable between the initial position and working position—as shown in FIG. 9—and the base frame 25 between the first and second end position by the travelling out length 98. The sliding drive 62 comprises the first and second transmission means engaging in the first driving gear 88 and in the second driving gear 91 and a third transmission means mounted on the coupling slide 29. The first transmission means is arranged fixed on an upper side facing the coupling slide on the lifting platform 22 and is formed by a gear rack 103 or a linearly tensioned chain, toothed belt, with which a toothed wheel or toothed disc forming the driving gear 88 meshes.

The second transmission means is also in the form of a gear rack 104 or a linearly tensioned chain or toothed belt, arranged on the coupling slide 29 on the underside facing the base frame 25, with which gear rack etc. the toothed wheel or toothed disc formed by the driving gear 91 meshes. The gear racks 103, 104 are aligned parallel to the travelling in and out direction—according to arrow 27, 28—and extend preferably approximately over the entire length of the lifting platform 22 or the coupling slide 29. The diameter of the driving gear 91 is greater than that of driving gear 88. The two driving gears 88, 91 are mounted driveably on the not shown common drive shaft on base frame 25 and are coupled by a not shown rotational movement transmission member, in particular a cardan shaft, such as articulated shaft, with the sliding motor 26 arranged on the lifting platform 22.

The third transmission means is, as already described in detail above, formed by the third pulley means 94, which is guided running endlessly around two guide rollers 95 mounted at the ends of the coupling slide 29, and is connected by the work drive elements 96, 69 on the one hand with the base frame 25 and on the other hand with the upper slide 30 in a drive terms.

If the two driving gears 88, 91 are both set into rotation by the drive shaft, on the one hand the base frame 25 is moved into travelling out direction—according to arrow 28—out of its first end position central relative to the lifting platform 22 and into a second end position that is eccentric to the lifting platform 22, as shown in FIG. 9, relative to the lifting platform 22 and at the same the coupling and upper slide 29, 30 is also moved in the same direction in travelling out direction—according to arrow 28—depending on the transmission ratio between the driving gear 88 and 91 synchronously relative to one another and relative to the base frame 25.

In a different design, that is not shown, the first, second driving gear 88, 91 is formed by a friction wheel drive, and the first, second transmission means is formed by a frictional surface arranged on the upper side of the lifting platform 22 or the underside of the coupling slide 29 parallel to the travelling in and out direction 27, 28.

In the following with reference to FIG. 1 the loading and unloading procedure of containers into or out of the rack compartment 9 is described, whereby with the load bearing device 23 indicated by solid lines, a container is unloaded or removed from the storage space 34 of the rack compartment 9 remote from the aisle, and by means of the height adjusted load bearing device 23 indicated by dashed lines a container is loaded in the storage space 34 remote from the aisle. The load bearing device 23 indicated by dash-dot lines shows the initial position of the bearing device 24. The aisle-remote storage space 34 corresponds to a rear depth position, as viewed in travelling out direction—according to arrow 28—of the upper slide 30, whereas the storage place 33 next to the aisle corresponds to a front depth position, as viewed in travelling out direction—according to arrow 28—of the upper slide 30.

In the unloading process the container to be removed is supported with its flat underside 106 on the horizontal storage surface 35. The load bearing device 23 that can be driven laterally next to the rack compartment 9 perpendicular and along the rack aisle 6 is driven until the bearing surface 74 is slightly higher than the underside 106 of the container or than the storage surface 35 of the rack compartment 9. After operating the sliding motor 26, the bearing device 24, therefore the base frame 25, coupling and upper slide 29, 30, together with the conveying means 32 are moved out to the side in moving out direction according to arrow 28—optionally to the right or left in a telescopic manner underneath the container.

The synchronously driven conveying means 32 are driven by the conveyor motor 31 on the bearing side opposite the moving out direction—according to arrow 28—of the upper slide 30 in conveying direction—according to the arrow 107. The conveying speed of the bearing surface 74 of the conveying means 32 in conveying direction—according to arrow 107—corresponds to the moving out speed in moving out direction—according to arrow 28 —of the upper slide 30 and is kept constant after the starting phase during the entire duration of the moving out movement of the upper slide 30.

The front end of the upper slide 30 in moving out direction—according to arrow 28—is provided with a contact means 108 rising up to the level of the bearing surface 74. During the moving out movement of the upper slide 30 the conveying means 32 drive under the container, whereby the wedge-shaped contact means 108 push underneath the container and lift the latter, so that it lies partly on the conveying means 32, and by the continuous travelling out movement of the upper slide 30 the container is lifted from the storage surface 35 to the level of the bearing surface 74. As the conveying speed corresponds to the moving out speed, the conveying means 32 roll off on the underside 106 of the container without relative displacement to the container, whereby the latter is lifted at the end of the movement completely from the storage surface 35 to the level of the bearing surface 74. As relative displacements between the container and the conveying means 32 are avoided, no great forces act on the container, which would cause compression to the container or other damage due to the action of force. The contact means 108, in particular a contact slope, can be formed by the end side guiding area of the conveying means 32 or by in the end regions of the upper slide 32 at least one contact roller arranged lower than the conveying means 32. Preferably in each end region of the upper slide 32 there are two contact rollers arranged after the conveying means 32 in travelling out direction—according to arrow 28— and positioned lower than the conveying means 32. The diameter of the contact rollers mounted on the upper slide 32 is preferably smaller than that of the guide rollers 51 and runs along a horizontal longitudinal axis of the contact roller perpendicular to the longitudinal extension of the upper slide 32.

Simultaneously or staggered from the moving out movement—according to arrow 28—of the coupling and upper slide 29, 30, the base frame 25 bearing the latter is moved by the displacement and/or actuating drive 62; 67 in the direction of the travelling out movement—according to arrow 28—by the predeterminable displacement path 73. In this way it is now also possible even with load bearing devices 23 with bearing devices 24 which form an overlapping area 64 defined by the conveying means and/or sliding drive 52, 62 which delimits the maximum extension length 63 of the fully driven out upper slide 30 from the base frame 25, to drive almost completely under the container with the conveying means 32 or the upper slide 30 which container is placed in the storage space 34 remote from the aisle and furthest from the shelf aisle 6. In this case before the at least one loading means 10 is transferred from the storage surface 35 out of the shelf compartment 9 by the conveying means 32, the base frame 25 is moved in travelling in or out direction—according to arrow 27, 28 by about the length of the overlapping area 64.

In the loading procedure the container to be transferred into the shelf compartment 9, for example the second storage space 34 in the shelf compartment 9, lies on the storage surface 74 of the conveying means 32. The load bearing device 23 shown by dashed lines is driven so far until the storage surface 35 intended to hold the container lies slightly below the bearing surface 74 or the underside 106 of the container. The base frame 25, coupling and upper slide 29, 30 with the conveying means 32 and the at least one container lying thereon are driven out relative to the lifting platform 22 in travelling out direction—according to arrow 28—over the storage surface 35 until the container lies completely over the storage surface 35 of the storage space 34. After this the coupling and upper slide 29, 30 is pulled back together with the conveying means 32 in travelling in direction—according to arrow 27, whereby at the same time the conveying means 32 are driven on the bearing side by the conveying means drive 52 opposite the travelling in direction—according to arrow 27—in conveying direction—according to arrow 107. The conveying speed corresponds to the travelling in speed, so that the conveying means 32 rolls off on the underside 106 of the container without relative displacement to the container. From the container its bearing on the conveying means 32 is removed so that it tilts with its rear end in travelling in direction—according to arrow 27—onto the lower storage surface 35. The loading procedure is ended when the container lies completely on the storage surface 35 and the conveying means 32 with the upper slide 30 is moved on completely underneath the container. In this case before the at least one loading means 10 is unloaded by the conveying means 32 onto the storage surface 35 in the shelf compartment 9, the base frame 25 is moved in travelling in or out direction—according to arrow 27, 28—by about the length of the overlapping area 64.

It should be mentioned that during the travelling in movement while unloading and the travelling out movement while loading the conveying means 32 with at least one container placed thereon are switched off or driven at a lower conveying speed than the travelling in and out speed, whereby then the conveying direction corresponds to the travelling in and out direction—according to arrow 27, 28. It is also possible for two containers to be loaded or unloaded simultaneously by means of the bearing device 24.

As the conveying motor 31 and sliding motor 26 of the conveyor means drive 52 and sliding drive 62 are driven separately, the travelling in and out movement of the bearing device 24, in particular the upper slide 30, and the feed movement are controlled separately by the synchronously running conveying means 32.

The embodiments show possible design variants of the load bearing device 23, whereby it should be noted, that the invention is not restricted to the embodiments shown specifically, but rather diverse combinations of the individual embodiments are possible, and these possible variations due to technical teaching of the present invention lie within the capability of one skilled in this technical field. Thus all possible design variants, which are possible by means of combining individual details of the embodiment variants shown and described, are also included within the scope of protection.

Lastly, for form's sake it is pointed out that for a better understanding of the structure of the load bearing device 23, the latter and its components have partly not been drawn to scale and/or have been enlarged and/or reduced in size.

The individual designs shown in detail in the FIGS. 1 to 7; 8; 9 mainly form the subject matter of independent solutions according to the invention. The objectives and solutions according to the invention can be taken from the detailed descriptions of these Figures.

### LIST OF REFERENCE NUMBERS

| | |
|---|---|
| 1 | Storage system |
| 2 | Rack store |
| 3 | Rack store |
| 4 | Loading and unloading side |
| 5 | Loading and unloading side |
| 6 | Rack aisle |
| 7 | Aisle width |
| 8 | Depth |
| 9 | Rack compartment |
| 10 | Loading means |
| 11 | Conveying device |
| 12 | Guiding track |
| 13 | Guiding track |
| 14 | Moving device |
| 15 | Moving device |
| 16 | Standing surface |
| 17 | Cover |
| 18 | Drive arrangement |
| 19 | Mast |
| 20 | Guiding arrangement |
| 21 | Lifting drive |
| 22 | Lifting platform |
| 23 | Load bearing device |
| 24 | Bearing device |
| 25 | Base frame |
| 26 | Sliding motor |
| 27 | Arrow |
| 28 | Arrow |
| 29 | Coupling slide |
| 30 | Upper slide |
| 31 | Conveyor motor |
| 32 | Conveying means |
| 33 | Storage space |
| 34 | Storage space |
| 35 | Storage surface |
| 36 | Angle profile |
| 37 | Rack support |
| 43 | Double arrow |
| 44 | Base |
| 45 | Base profile |
| 46 | Profile arm |
| 47 | Profile arm |
| 48 | Running block |
| 49 | Axle pin |
| 50 | Guide roller |
| 51 | Guide roller |
| 52 | Conveying means drive |
| 53 | Extension |
| 54 | Running block |
| 55 | Running track |
| 56 | Upper belt |
| 57 | Lower belt |
| 58 | Web |
| 59 | Running track |
| 60 | Arm |
| 62 | Sliding drive |
| 63 | Extension length |
| 64 | Overlapping area |
| 65 | End face |
| 66 | End face |
| 67 | Actuating drive |
| 68 | Linear guiding device |
| 69 | Guiding bar |
| 70 | Slide |
| 71 | Plane of symmetry |
| 72 | Side delimitation |
| 73 | Adjustment path |
| 74 | Bearing surface |
| 75 | Pulley means |
| 76 | Pulley means |
| 77 | Driving gear |
| 78 | Guide roller |
| 79 | Guide roller |
| 80 | Coupling shaft |
| 81 | Drive roller |
| 82 | Guide roller |
| 83 | Drive shaft |
| 84 | Rotational movement transfer member |
| 85 | End |
| 86 | End |
| 87 | Pulley means |
| 88 | Driving gear |
| 89 | Guide roller |
| 90 | Pulling means |
| 91 | Driving gear |
| 92 | Guide roller |
| 93 | Securing point |
| 94 | Pulling means |
| 95 | Guide roller |
| 96 | Work drive element |
| 97 | Work drive element |
| 98 | Travelling out length |
| 99 | Actuating motor |
| 100 | Bearing block |
| 101 | Threaded spindle |
| 102 | Spindle nut |
| 103 | Gear rack |
| 104 | Gear rack |
| 106 | Underside |
| 107 | Arrow |
| 108 | Contact means |
| 109 | End face |

1. Load bearing device (23), in particular for the loading and unloading of loading means (10) into or out of a rack compartment (9) of a rack store (2, 3) with an adjustable lifting platform (22) laterally adjacent to the rack store (2, 3), with a bearing device (24) mounted on the lifting platform (22) for bearing, if necessary, at least one loading means (10), which bearing means comprises a base frame (25) and at least one sliding drive (62) and coupling and upper slides (29, 30) adjustable in travelling in and out direction (27, 28) synchronously and relative to the base frame (25), and at least one conveying means (32) mounted on the upper slide (30), in particular a conveyor belt, for transporting the loading means (10) by means of frictional locking, which conveying means (32) is coupled with a conveying means drive (52) comprising two pulley drives, of which a first pulley means (75) is guided by a first pulley means drive running from a driving gear (77) mounted on the base frame (25) and driveable by a conveyor motor (31) over two guide rollers (78) mounted on the base frame (25) at its two sides and two guide rollers (79) mounted at the ends of the coupling slide (29), and a second pulley means (76) of the second pulley means is guided on two guide rollers (50) mounted on the upper slide (30) and is coupled moveably with the coupling slide (29), and the base frame (25), coupling and upper slide (29, 30) are designed respectively to have approximately the same length and are guided towards one another, and a maximum advance length (63) of the moved out upper slide (30) between end sides of the base frame (25) and upper slide (30) that are at the front in travelling out direction (28) is smaller than the length of the base frame (25) and is delimited by a overlapping areas (64) resulting from the guiding of the pulley means (75, 76) on the guide rollers (50, 79) between opposite end sides (65, 66) of the base frame (25) and upper slide (30), wherein by means of the upper slide (29, 30) viewed in travelling out direction (28), at least two depth positions lying behind one another for the loading means (10) can be approached in the rack compartment (9) of the rack store (2, 3), and in that the conveying means and sliding drive (52, 62) has motors (31, 26) that can be driven separately and are secured onto the lifting platform (22), and the second pulley means (76) is guided by the second pulling means drive for the conveying means drive (52) around a first guide roller (50) mounted on the upper slide (30) and driven by the first pulley means (75) and a second guide roller (50) mounted at one end of the upper slide (30), and the conveying means (32) can be driven by means of the second pulley means (76) and the second guide roller (50), and in that the sliding drive (62) comprises at least one pulley means drive coupled with the sliding motor (26) and arranged separately from the pulley means drives for the conveying means drive (52), and in that between the bearing device (24), in particular the base frame (25) and the lifting platform (22) at least one actuating drive (67) and a linear guiding device (68) running parallel to the travelling in and out direction (27, 28) is arranged, and in that the bearing device (24) is guided along the linear guiding device (68) and is adjustable by the actuating drive (67) in travelling in and out direction (27, 28) by about the length of the overlapping area (64), such that the conveying means (32) can be moved out up to at least one rear end face (109) viewed in travel out direction (28) of a loading means (10) positioned in the rack compartment (9), and in this way the loading means (10) completely drives down in travelling in and out direction (27, 28) on its underside.

2. Load bearing device according to claim 1, wherein the actuating drive (67) is designed separately from the sliding drive (62) and comprises a pneumatically, hydraulically or electrically operated linear drive.

3. Load bearing device according to claim 2, wherein the linear drive comprises the linear guiding device (68).

4. Load bearing device according to claim 2, wherein the linear drive comprises an actuating motor (99) and in that the sliding, conveying and/or actuating motor (26, 31, 99) are synchronised by the sliding drive, the conveying means drive and/or actuating drive (62, 52, 67).

5. Load bearing device according to claim 1, wherein the actuating drive (67) is formed by the sliding drive (62).

6. Load bearing device according to claim 5, wherein the sliding drive (62) comprises a first driving gear (88) mounted on the base frame (25) and coupled with the sliding motor (26) fixed onto the lifting platform (22) and a first transmission means arranged between the base frame (25) and the lifting platform (22) and engaging or contacting with the first driving gear (88).

7. Load bearing device according to claim 6, characterised in that the first driving gear (88) is formed by a toothed wheel or a toothed disc and the first transmission means is formed by a gear rack (103) secured onto the lifting platform (22) parallel to the driving in or out direction (27, 28), or a linearly tensioned chain or a toothed belt.

8. Load bearing device according to claim 6, wherein the first driving gear (88) is formed by a frictional wheel and the first transmission means by a frictional surface arranged on the lifting platform (22) parallel to the travelling in or out direction (27, 28).

9. Load bearing device according to claim 6, wherein the first transmission means is formed by a first pulley means (87), that is guided by the first driving gear (88) over two guide rollers (89) secured onto the base frame (25), and the two ends (85) of the first pulley means (87) are connected securely at securing points (93) to the lifting platform (22).

10. Load bearing device according to claim 1, wherein the sliding drive (62) comprises a second driving gear (91) mounted on the base frame (25) and coupled with the same sliding motor (26), and a second transmission means arranged between the base frame (25) the coupling slide (29) and engaging or contacting with the second driving gear (91).

11. Load bearing device according to claim 10, wherein the second driving gear (91) is formed by a toothed wheel or a toothed disc and the second transmission means is formed by a gear rack (104) secured onto the coupling slide (29) parallel to the travelling in or out direction (27, 28) or a linearly tensioned chain or a toothed belt.

12. Load bearing device according to claim 10, wherein the second driving gear (91) is formed by a frictional wheel and the second transmission means is formed by a frictional surface arranged on the coupling slide (29) parallel to the travelling in or out direction (27, 28).

13. Load bearing device according to claim 10, wherein the second transmission means is formed by a second pulley means (90), which is guided by the second driving gear (91) over two guide rollers (92) arranged centrally on the base frame (25) to securing points (93) arranged in travelling out direction (28) of the telescopic support device (24) at the ends of the coupling side (29), and the two ends (86) of the second pulley means (90) are securely connected to the coupling slide (29).

14. Load bearing device according to claim 5, wherein the sliding drive (62) comprises a third pulley means (94), which is guided running endlessly around two guide rollers (95) mounted in travel out direction (28) of the telescopic bearing device (24) at the ends of the coupling slide (29), and the coupling slide (29) is connected via a first work drive element (96) to the base frame (25) and the upper slide (30) via an additional work drive element (97) to the coupling slide (29) in a moving mechanical manner, whereby the first work drive element (96) is secured to a lower strand side of the third pulley means (94) facing the base frame (25) and a frame of the base frame (25), and the additional work drive element (97) is secured to a upper strand side facing the upper slide and a frame of the upper slide (30).

15. Load bearing device according to claim 6, wherein the driving gears (88, 91) form a transmission and are arranged on a common drive shaft, and in that drive shaft is coupled via a rotational movement transmission member (84), in particular a cardan shaft, with the sliding motor (26) arranged in a fixed manner on the lifting platform (22).

16. Load bearing device according to claim 1, wherein the base frame (25) of the bearing device (24) is arranged on the lifting platform (22), and in relation to the lifting platform (22) is designed to be adjustable in two directions beyond the opposite side delimitations (72) of the lifting platform (22) by about the length of the overlapping area (64).

17. Load bearing device according to claim 1 wherein an adjustment path (73) of the base frame (25) parallel to the travelling in or out direction (27, 28) corresponds at least to the length of the overlapping area (64) and is between about 130 mm and 250 mm, in particular 150 mm and 200 mm, for example 170 mm.

18. Load bearing device according to claim 1, wherein the linear guiding device (68) comprises at least one guiding bar (69) running in travelling in or out direction (27, 28) and secured onto the lifting platform (22) and at least one slide (70) secured to the base frame (25), whereby the bearing device (24) is mounted by the slide (70) on the guiding bar (69).

19. Method, in particular for the loading and unloading of loading means (10) into or out of a rack compartment (9) of a rack store (2, 3), by means of a bearing device (24) with a base frame (25) and coupling and upper slides (29, 30) that are adjustable synchronously to one another and relative to the base frame (25) in travelling in and out direction (27, 28), and at least one driveable conveying means (32) arranged on the upper slide (30) and a load bearing device (23) arranged on an adjustable lifting platform (22) according to one of claims 1 to 18, in which for unloading the upper slide (29, 30) with the running conveying means (32) driven over pulleys (75, 76) of the bearing device (24) positioned in front of the rack compartment (9) drives out under at least one loading means (10) placed on a storage surface (35) in the rack compartment (9) in direction (28) until it reaches a maximum of an advance length (63) defined by an overlapping area (64) resulting from the guiding of the pulleys (75, 76) on guide rollers (50, 79) between opposite end sides (65, 66) of the base frame (25) and upper slide (3), the conveying means (32) takes up the loading means (10), and then the upper slide (29, 30) returns in travelling in direction (27), and in which for loading the upper slide (29, 30) of the bearing device (24) with the loading means (10) placed on the conveying means (32) drives out in travelling out direction (28) at most up to the extension length (63) delimited by the overlapping area (64) between opposite end sides (65, 66) of the base frame (25) and upper slide (30) resulting from the guiding of the pulley means (75, 76) on guide rollers (50, 79), the conveying means (32) transfers the loading means (10) onto the storage surface (35) on the shelf compartment (9) and then the upper slide (29, 30) returns in driving in direction (27), wherein on unloading and loading a loading means (10) by the upper slide (3) viewed in travelling out direction (28), a front or rear depth position is approached and by the running conveying means (32) a loading means (10) placed on the front or rear depth position is taken onto the upper slide (30) or a loading means (10) is placed by the upper slide (30) on the shelf compartment (9) in the front or rear depth position, whereby the in and out movement of the upper slide (30) and feed movement of at least one conveying means (32) are driven separately by two motors (31, 26) arranged on the lifting platform (22), and in that the bearing device (24), in particular the base frame (25), is moved in addition to the driving in and out movement of the upper slide (30) relative to the lifting platform (22) in travelling in or out direction (27, 28) by about the length of the overlapping area (64) such that the conveying means (32) drives out up to at least one rear end face (109) viewed in travelling out direction (28) of a loading means (10) placed in the shelf compartment (9) and thereby drives underneath the loading means (10) in travelling in or out direction (27, 28) on its underside.

20. Conveyor device (11), in particular a rack operating device, with an essentially vertically and horizontally adjustable lifting platform (22) and at least one load bearing device (23) arranged on the lifting platform (22), wherein the at least one load bearing device (23) is designed according to claim 1.
